(19) United States
(12) Patent Application Publication
(10) Pub. No.: US 2025/0144877 A1
(43) Pub. Date: May 8, 2025

(54) PORTABLE AND FOLDABLE 3D PRINTER

(71) Applicant: BYLD INNOVATIONS INC, Wilmington, DE (US)

(72) Inventors: Karan Jain, Champaign, IL (US); Siddhant Sachin Kale, Champaign, IL (US)

(21) Appl. No.: 18/816,226

(22) Filed: Aug. 27, 2024

Related U.S. Application Data
(60) Provisional application No. 63/547,463, filed on Nov. 6, 2023.

(51) Int. Cl. B29C 64/25; B33Y 30/00

(52) U.S. Cl. CPC B29C 64/25; B33Y 30/00

(57) ABSTRACT

A 3D printer that includes a base assembly and an extruder assembly coupled to the base, the extruder assembly including an extruder. The 3D printer is reconfigurable between a folded configuration, in which the base assembly is base assembly is substantially co-planar to the extruder, and an extruding configuration, in which the extruder is disposed above the base assembly and configured to print parts on the base assembly.

### FIELD OF THE DISCLOSURE

The present disclosure generally relates to 3D printers and, more particularly, to a portable and foldable 3D printer.

### BACKGROUND

3D printers revolutionize manufacturing by creating three-dimensional objects from digital designs. 3D printers work by depositing material layer by layer, a process known as additive manufacturing. However, known 3D printers are very large, stationary machines that can be located anywhere, from a warehouse to a classroom, but are difficult to carry and move. As a result, known 3D printers are also quite expensive.

### SUMMARY

In accordance with a first exemplary aspect of the present invention, a 3D printer configured to be foldable and portable is provided. The 3D printer includes a base assembly and an extruder assembly coupled to the base, the extruder assembly including an extruder. The 3D printer is reconfigurable between a folded configuration, in which the base assembly is base assembly is substantially co-planar to the extruder, and an extruding configuration, in which the extruder is disposed above the base assembly and configured to print parts on the base assembly.

In accordance with a second exemplary aspect of the present invention, a 3D printer is configured to be foldable and portable. The 3D printer includes a base assembly that includes a bed, a bed support for the bed, and a slot frame coupled to the bed support. The slot frame includes one or more slots. The 3D printer includes an extruder assembly coupled to the base assembly. The extruder assembly includes an extruder and a pin support. The pin support includes one or more projections movably disposed in the one or more slots. The 3D printer is reconfigurable between a folded configuration, in which the base assembly is co-planar to the extruder assembly, and an extruding configuration, in which the extruder assembly is disposed above the base assembly and configured to print parts on the bed. The 3D printer is reconfigurable between the folded configuration and extruding configuration via movement of the one or more projections in the one or more slots.

### BRIEF DESCRIPTION OF THE FIGURES

FIG. 1 shows a perspective view of a first example of a portable and foldable 3D printer in accordance with the teachings of the present disclosure, the 3D printer in an extruding configuration.

FIG. 2 shows a front view of the first example of the portable and foldable 3D printer in the extruding configuration.

FIG. 3 shows a back view of the first example of the portable and foldable 3D printer in the extruding configuration.

FIG. 4 shows a top view of the first example of the portable and foldable 3D printer in the extruding configuration.

FIG. 5 shows a bottom view of the first example of the portable and foldable 3D printer in the extruding configuration.

FIG. 6 shows a left view of the first example of the portable and foldable 3D printer in the extruding configuration.

FIG. 7 shows a right view of the first example of the portable and foldable 3D printer in the extruding configuration.

FIG. 8 shows a perspective view of the first example of the portable and foldable 3D printer in a folded configuration.

FIG. 9 shows a top view of the first example of the portable and foldable 3D printer in the folded configuration.

FIG. 10 shows a front view of the first example of the portable and foldable 3D printer in the folded configuration.

FIG. 11 shows a left view of the first example of the portable and foldable 3D printer in the folded configuration.

FIG. 12 is a cross-sectional view taken along line A-A in FIG. 11, showing a perspective view.

FIG. 13 is a cross-sectional view taken along line A-A in FIG. 11, showing a top view.

FIG. 14 is a cross-sectional view taken along line B-B in FIG. 10.

FIG. 15A shows a close-up, front view of a first housing of an extruder assembly of the first example of the portable and foldable 3D printer.

FIG. 15B shows a close-up, perspective view of the first housing of FIG. 15A.

FIG. 16A shows a close-up view of a slot frame of a base assembly of the first example of the portable and foldable 3D printer.

FIG. 16B is a close-up, perspective view of the slot frame of FIG. 16A.

FIG. 17 shows a close-up view of a bed of the base assembly of the first example of the portable and foldable 3D printer.

FIG. 18 shows a close-up and isolated view of one main bed support of the first example of the portable and foldable 3D printer.

FIG. 19 shows a close-up and isolated view of both main bed supports of the first example of the portable and foldable 3D printer.

FIG. 20 shows a close-up view of a sliding lock of the first example of the portable and foldable 3D printer.

FIG. 21 shows a perspective view of a second example of the portable and foldable 3D printer in accordance with the teachings of the present disclosure, the 3D printer in an extruding configuration.

FIG. 22 shows a front view of the second example of the portable and foldable 3D printer in the extruding configuration.

FIG. 23 shows a right view of the second example of the portable and foldable 3D printer in the extruding configuration.

FIG. 24 shows a bottom view of the second example of the portable and foldable 3D printer in the extruding configuration.

FIG. 25 shows another perspective view of the second example of the portable and foldable 3D printer in the folded configuration.

### DETAILED DESCRIPTION

The 3D printer disclosed herein aims to address the problems discussed above as well as other problems related to known 3D printers. In particular, the 3D printer disclosed herein is configured to fold up into a smaller overall package size, such that the 3D printer is more space efficient than known 3D printers and is significantly easier to carry and move than known 3D printers. Beneficially, the smaller size and improved modularity of the design do not compromise the effectiveness of the printing capabilities of the 3D printer.

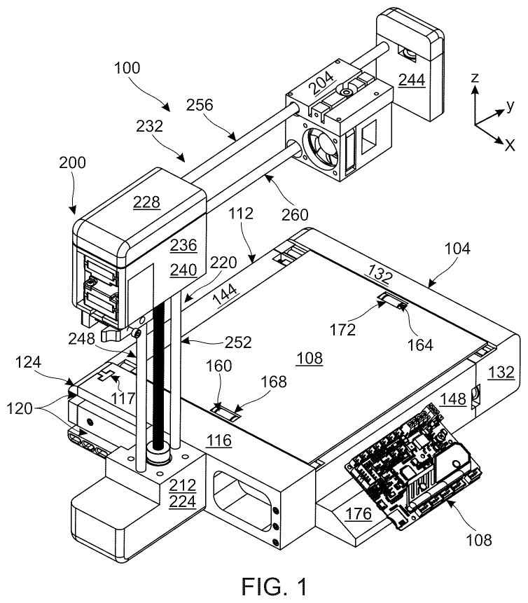

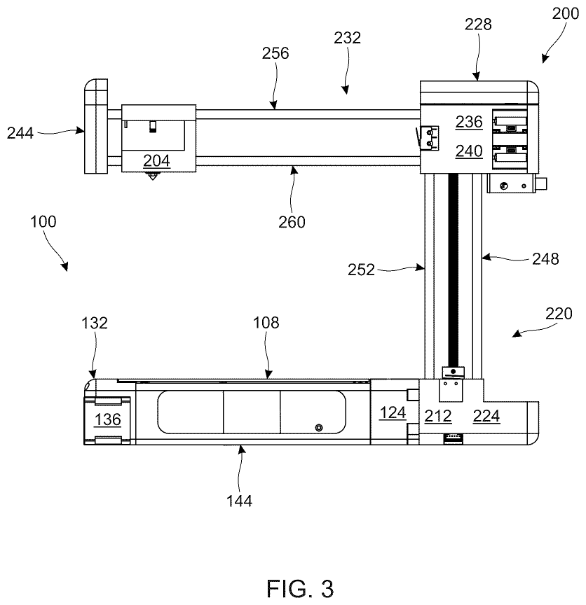

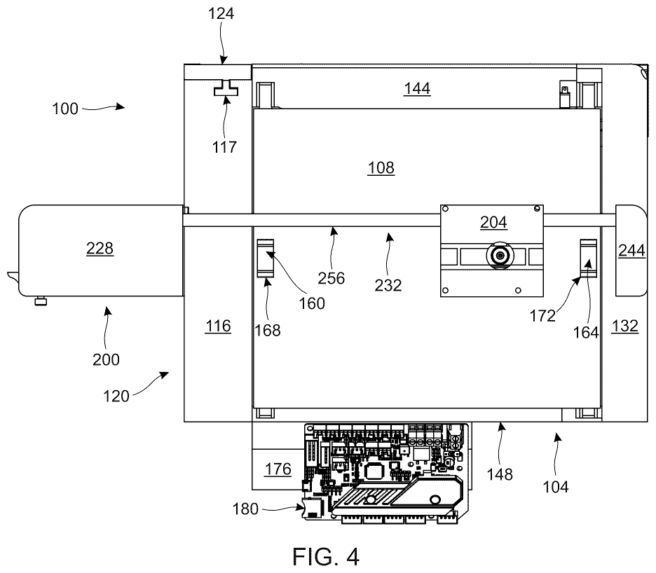

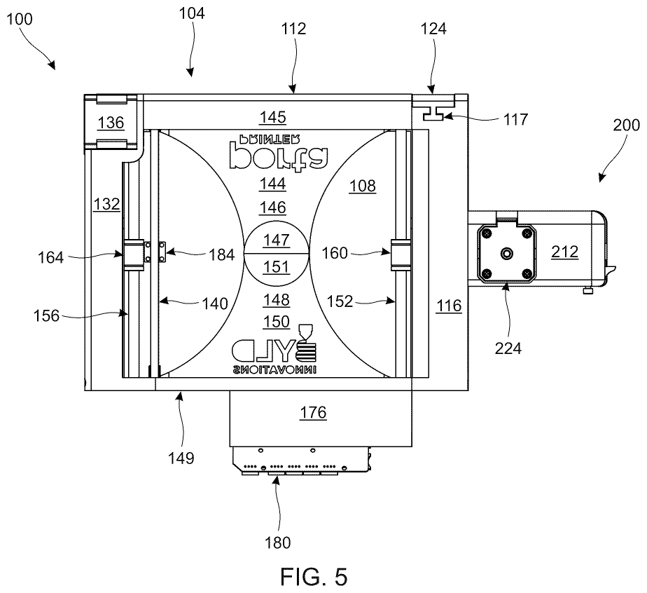

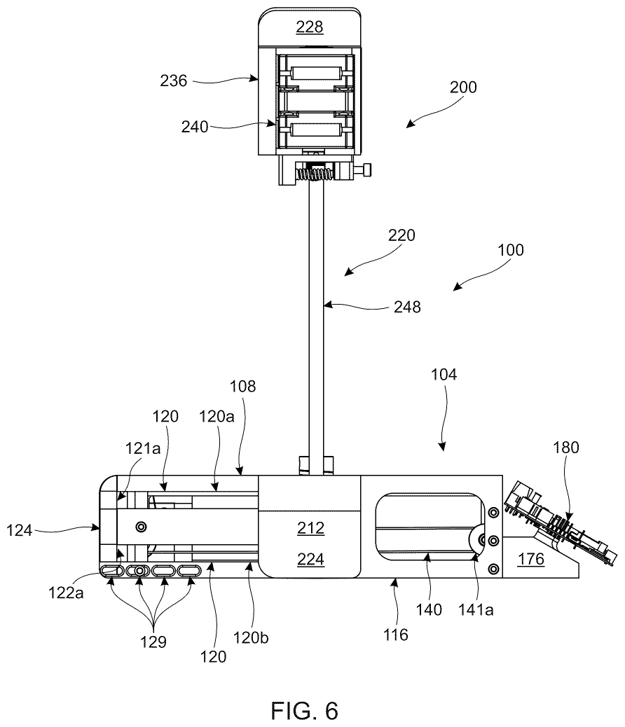

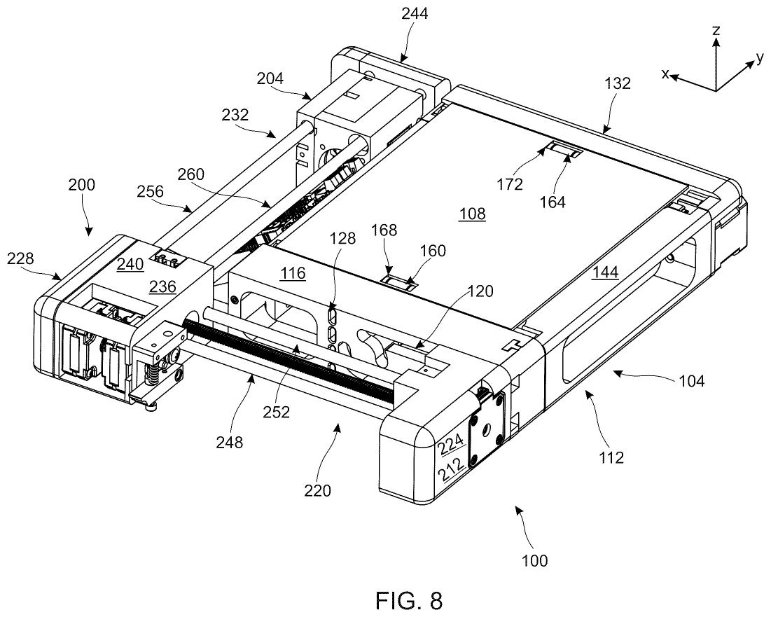

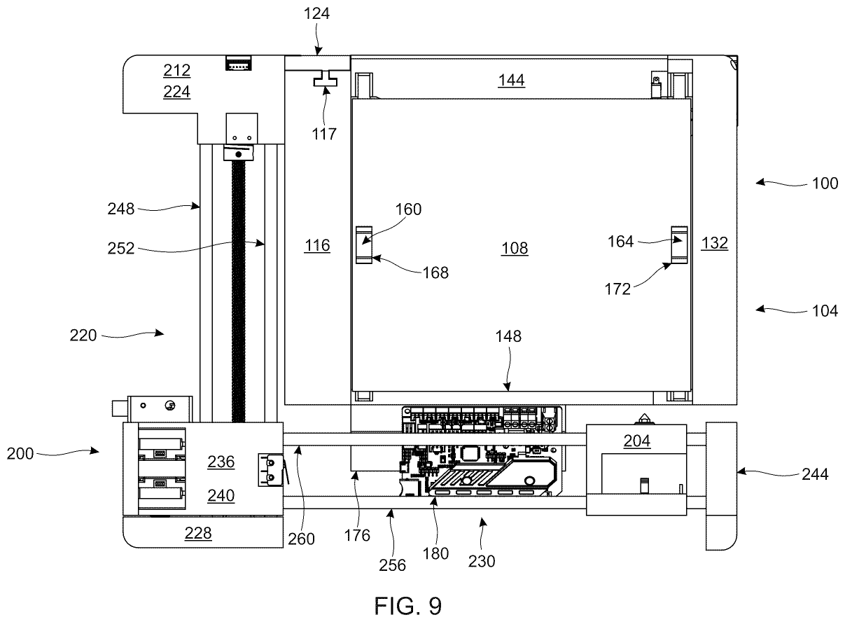

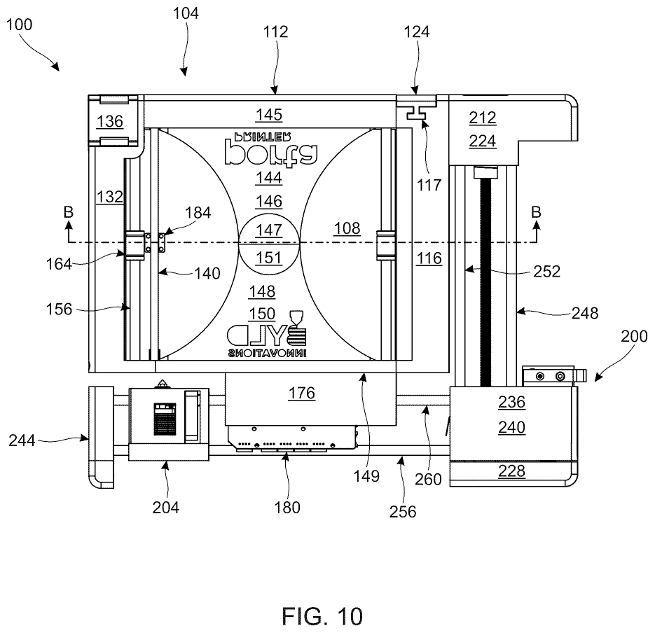

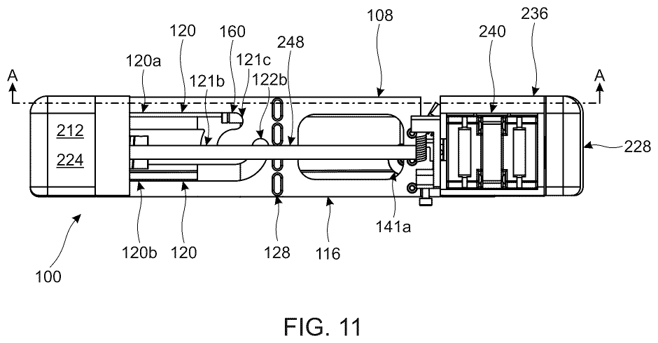

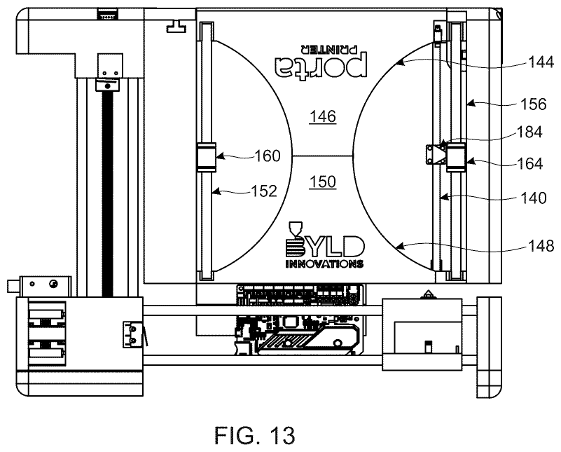

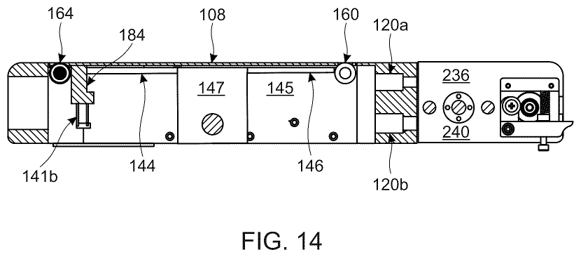

FIGS. 1-20 illustrate a first example of a 3D printer 100 constructed in accordance with the teachings of the present disclosure. The 3D printer 100 generally includes a base assembly 104 and an extruder assembly 200 that is coupled to the base assembly 104 and includes an extruder 204. The 3D printer 100 (and more particularly the extruder assembly 200) is generally reconfigurable between two configurations, an extruding configuration (FIGS. 1-7) and a folded configuration (FIGS. 8-14). In the extruding configuration, the extruder 204 is disposed above the base assembly 104 and is in position to create printed parts on the base assembly 104. In the present example, in the extruding configuration the extruder assembly 200 is substantially in the y-z plane (see FIG. 1). Meanwhile, in the folded configuration, the extruder 204 lies substantially in the same plane as the base assembly 104. In the present example, that plane is the x-y plane (see FIG. 8).

As best illustrated in FIGS. 1 and 8, the base assembly 104 includes a bed 108, a bed frame 112, and a slot frame 116 coupled to the bed 108 and the bed frame 112. The bed 108 is generally configured to provide space for and support parts printed by the extruder 204 when the 3D printer 100 is in the extruding configuration. The bed frame 112 is generally configured to support the bed 108, particularly when the 3D printer 100 is in the extruding configuration and the extruder 204 is printing parts. Further details regarding the bed 108 and the bed frame 112 will be described below. The slot frame 116 is generally configured to facilitate selective movement of the extruder 204 to move the 3D printer 100 between its folded and extruded configurations. More particularly, the slot frame 116 includes a rigid, multi-segmented structure with one or more strategically positioned pin slots 120 designed to facilitate the movement of the extruder assembly 200 from the folded configuration to the extruding configuration, and vice versa.

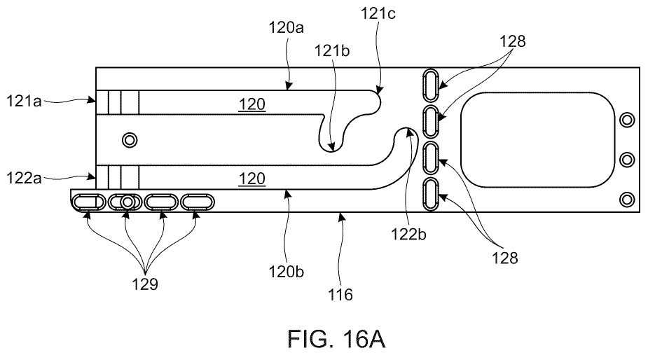

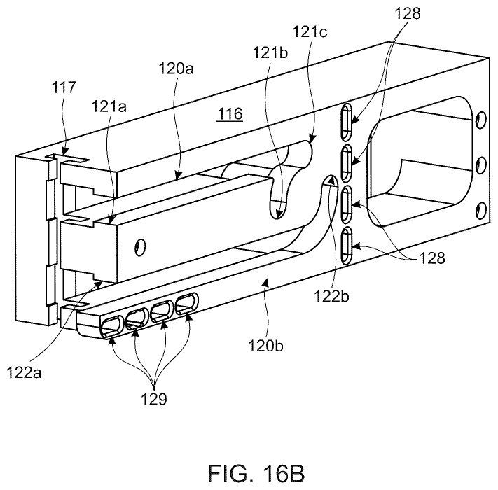

In this example, the slot frame 116 includes two independent pin slots 120 (see FIGS. 16A and 16B), a first slot 120A and a second slot 120B that is structurally separate from the first slot 120A. In this example, the first slot 120a has a curved shape defined by a first, open end 121a, a second end 121b, and an intermediate stop 121c disposed in the slot 120a between the first end 121a and the second stop 121b. As best illustrated in FIGS. 16A and 16B, the second end 121b in this example is disposed below (or closer to the second slot 120B than) the first end 121a and the intermediate stop 121c. Moreover, the slot 120b has a curved shape that is defined by a first, open end 122a and a second end 122b opposite the first end 122a. As best illustrated in FIGS. 16A and 16B, the second end 122b in this example is disposed above the first end 122a and is horizontally aligned with the second end 121b. As also best illustrated in FIGS. 16A and 16B, the first end 121a and first end 122a are disposed immediately adjacent an opening 117 of the slot frame 116. The pin slots 120 serve as a pivot point for the folding of the 3D printer 100 by receiving projections 208 of the extruder assembly 200 that are inserted in the pin slots 120, respectively. As will be discussed in more detail below, the extruder assembly 200 moves from the folded configuration to the extruding configuration when the projections 208 move from the second ends 121b and 122b to the first ends 121a and 121b, respectively.

One of ordinary skill in the art would understand that the slot frame 116 can include any number of independent slots and/or the slots can be interconnected together. Moreover, while in the present example the slot frame 116 is a 3D-printed part made of polylactic acid (“PLA”), one of ordinary skill in the art would understand that the slot frame 116 can be manufactured of any suitable material, including but not limited to a metal or other hard plastic material.

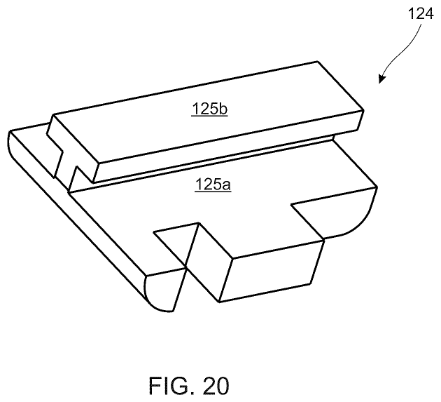

The 3D printer 100 also includes a removable locking mechanism removably coupleable to the slot frame 116 to help limit movement of the extruder assembly 200 relative to the base assembly 104, particularly when the 3D printer 100 is in its extruded configuration. In this example, the removable locking mechanism takes the form of a slide lock 124, as best illustrated in FIG. 20. The slide lock 124 is generally configured to be removably attached to the slot frame 116. The slide lock 124 in this example is a 3D-printed part and is manufactured of a material such as PLA (though one of ordinary skill in the art would understand the slide lock 124 can be composed of any suitable material). In this example, the slide lock 124 has a body 125a and a tab 125b that is coupled to and extends outward from the body 125a. The tab 125b is configured to be removably disposed in the opening 117 formed in a top of slot frame 116 so as to cap the end of the pin slots 120 and to secure the projections 208 within the slots 120, respectively, when desired. As best illustrated in FIGS. 16B and 20, the opening 117 in this example is a T-shaped opening and the tab 125b in this example has a T-shape that corresponds with the opening 117. However, one of ordinary skill in the art would appreciate that the tab 125a may have a different shape (e.g., a rectangular or cylindrical shape) and/or may connect with the opening 117 to form a different type of joint such as a dowel joint.

When the slide lock 124 is decoupled or removed from the slot frame 116, the projections 208 of a first housing 212 of the extruder assembly 200 can be slid sideways into or out of the slots 120, respectively, via the first ends 121a, 121b of the slots 120 formed immediately adjacent the opening 117 in the slot frame 116. But when the slide lock 124 is coupled to the slot frame 116, the slide lock 124 is disposed in the opening 117 and prevents the projections 208 of the first housing 212 from moving beyond the opening 117 of the pin slots 120 and out of the slots 120.

Finally, the slot frame 116 in this example also includes two sets of openings configured to selectively receive slot extrusions 216 carried by the first housing 212 depending upon whether the 3D printer 100 is in the extruding or folded configuration. The slot frame 116 includes a first set of openings 128 sized to receive the slot extrusions 216 to secure the extruder assembly 200 to the base assembly 104 when the 3D printer 100 is in the extruding configuration. In this example, the slot extrusions 216 form a mortise and tenon joint when disposed in the openings 128. Similarly, the slot frame 116 includes a set of openings 129 sized to receive the slot extrusions 216 of the first housing 212 to secure the extruder assembly 200 to the base assembly 104 when the 3D printer 100 is the folded configuration. In this example, the slot extrusions 216 form a mortise and tenon joint when disposed in the openings 129. Alternatively, however, the extruder assembly 200 can be selectively secured to the base assembly 104 in a different manner, such as with a latch or other joint including, for example, a dowel joint.

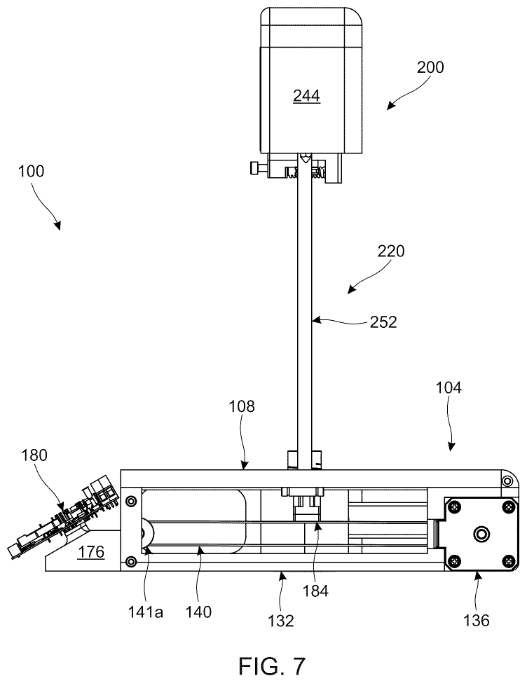

As best illustrated in FIG. 7, the base assembly 104 further includes a bed motor frame 132 that is coupled to the bed 108 and the bed frame 112 and houses a bed motor 136 for driving movement of the bed 108. In the present example, the bed motor frame 132 is coupled to the bed 108 and the bed frame 112 at a position opposite the slot frame 116 (i.e., the slot frame 116 and the bed motor frame 132 are coupled to opposing ends of the bed 108 and the bed frame 112). In the present example, the bed motor 136 is a Nema 17 Stepper motor with encoding mechanisms, but one of ordinary skill in the art would understand that the bed motor 136 can be any other suitable, similarly configured motor. Furthermore, in the present example, the bed motor frame 132 is a 3D-printed part manufactured of PLA just as the slot frame 116; however, one of ordinary skill in the art would understand that the bed motor frame can be manufactured of a different material, including but not limited to a metal or other hard plastic material.

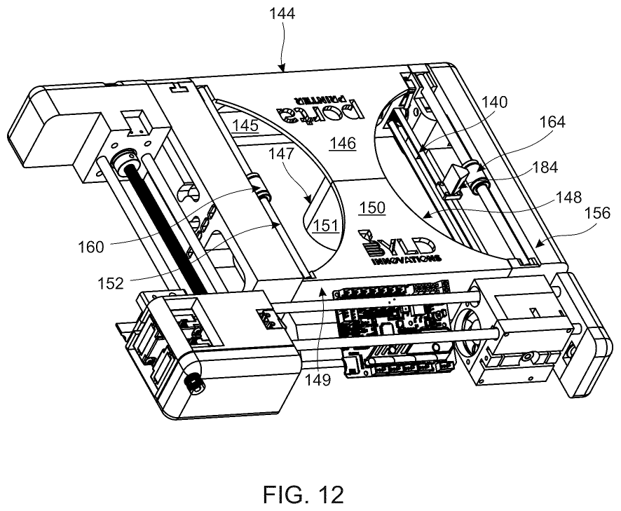

As best illustrated in FIGS. 1, 8, and 12-14, the base assembly 104 further includes the bed 108 and the bed frame 112, which supports the bed 108. In the present example, the bed 108 is a thin and substantially rectangularly shaped 3D-printed part that is made of PLA and presents a satisfactory surface for printing parts via the extruder 204. However, one of ordinary skill in the art would understand that in other examples can be thicker (or even thinner), can be a different shape (e.g., a circular, a triangular, or an irregular shape), and/or can be made of one or more different materials. When the 3D printer 100 is in the extruding configuration, the bed 108 is movable in the X-direction along the horizontal, X-Y plane so that the extruder 204 can print parts therein. In the present example, the bed motor 136 drives movement of the bed 108 in the X-direction by way of a belt 140 and a bed plate extrusion 184 that is coupled to the belt 140 and creates the lateral motion from the rotational motion of the bed motor 136. As best illustrated in FIGS. 12-14, the belt 140 in this example is disposed beneath the bed 108, is parallel to two rods 152, 156, and extends between pulleys 141a, 141b coupled to the bed motor 136. In the present example, the belt 140 takes the form of a GT2-2M timing belt mounted on the bed motor 136 by the belt pulleys 141a, 141b, which also take the form of GT2 pulleys. The bed plate extrusion 184 is secured to the belt 140 by a teethed board 188 that attaches to the teeth of the belt 140. However, one of ordinary skill in the art will understand that there are other suitable methods for creating the horizontal motion of the bed 108, including but not limited to a rack and pinion system or a pneumatic actuator, and that other suitable belt and pulley systems can be utilized in the 3D printer 100. Moreover, while the bed plate extrusion 184 in the present example is a 3D-printed part manufactured of PLA, one of ordinary skill in the art would appreciate that the bed plate extrusion 184 can be made of any suitable material, including hard plastic material or metal.

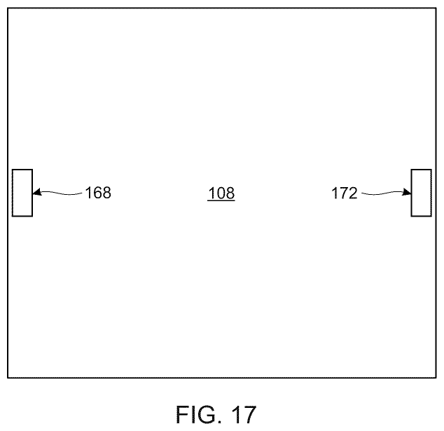

As best illustrated in FIG. 12-14, the bed frame 112 in this example includes two main bed supports 144, 148, the two rods 152, 156, and two ball bearings 160, 164. The two main bed supports 144, 148 are connected to form the base structure of the bed frame 112, and the bed 108 rests on the two ball bearings 160, 164, which are mounted to the two rods 152, 156 that are secured to the main bed supports 144, 148, respectively. The ball bearings 160, 164, in conjunction with the two linear rods 152, 156, allow for smooth, low-friction, constrained movement of the bed 108 in the X-direction when actuated by the bed motor 136 and, thus, the belt 140. The ball bearings 160, 164 are mounted to the bed 108 (and vice versa) through the rectangular cuts 168, 172 illustrated in FIG. 17, which in this example are positioned on the middle of either side of the bed 108. One of ordinary skill in the art would understand that in other examples, the bed frame 112 may include any combination of these or additional features, including, for example, one or three or more bed supports, a third or more linear rods, and more or less ball bearings or different components than the ball bearings 160, 164 for supporting the bed 108.

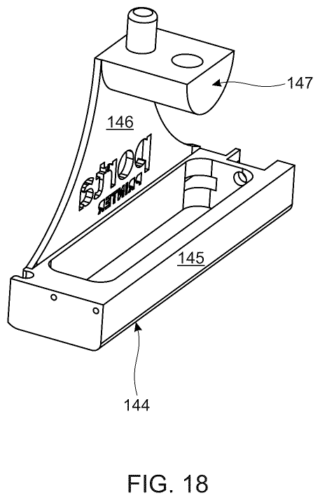

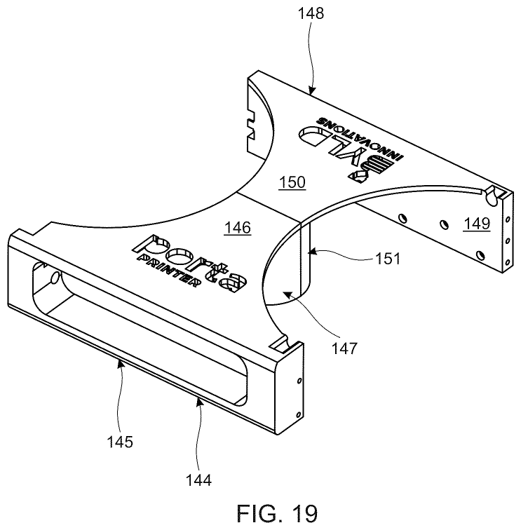

In the present example, the two rods 152, 156 are made of steel to constrain motion in the X direction for the ball bearings 160, 164 of the bed frame 112 during the 3D printing process. However, one of ordinary skill in the art would understand that other suitable materials can be used in other examples, including but not limited to a different metal or hard plastic material. Additionally, the ball bearings 160, 164 in this example are conventional ball bearings, but one of ordinary skill in the art would know that the ball bearings 160, 164 can be replaced with other components for structurally supporting the bed 108 (e.g. linear roller bearings or slide mechanisms). Finally, the main bed supports 144, 148 in this example are generally configured to structurally support the bed 108. As best illustrated in FIGS. 18 and 19, each of the main bed supports 144, 148 in this example has a base (145 and 149 respectively), a body (146 and 150, respectively) coupled to and extending outward from the base, and a connector (147 and 151, respectively) coupled to and extending outward from the body opposite the base. The main bed supports 144, 148 further include slots and mounting points for an electronics box 176 and to house gears, limit switches, and steel rods for the bed 108 X-axis movements, and extrusions to hold filament used in the 3D printing process. In the present example, the body of each of the main bed supports 144, 148 includes a slot whereas the connector of each of the main body supports includes an extrusion and an opening. In the present example, the main bed supports 144, 148 are coupled together at the center of the base assembly 104 through the extrusions and openings in the connectors, as the extrusion of a first one of the main bed supports 144, 148 is disposed in the opening of a second one of the main bed supports 144, 148 and the extrusion of the second main bed support 144, 148 is disposed in the opening in the first main bed support 144, 148. However, one of ordinary skill in the art would appreciate that the main bed supports 144, 148 can be coupled together in a different manner including, for example, by an adhesive or a different type of joint than the mortise and tenon joints illustrated in FIG. 19. Moreover, in the present example, the main bed supports 144, 148 are 3D-printed parts manufactured of PLA; however, one of ordinary skill in the art would understand that the main bed supports 144, 148 can be manufactured of any suitable material, including but not limited to a metal or other hard plastic material, and the 3D printer 100 may include one, three, or more than three main bed supports.

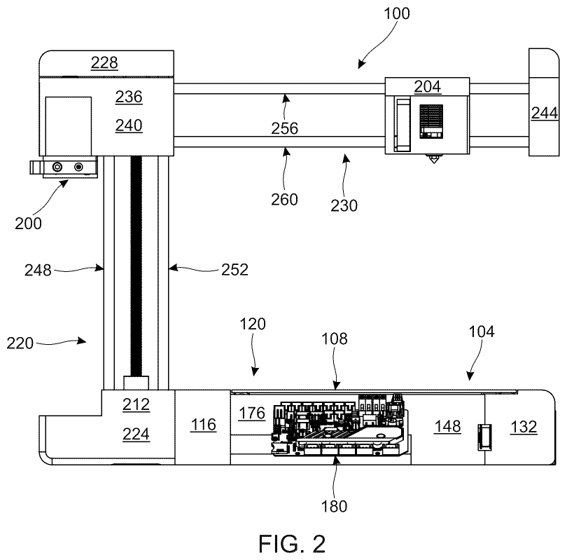

As illustrated in FIGS. 2, 4, and 9-10, the base assembly 104 further includes an electronics box 176 and a motherboard 180 coupled to the electronics box 176. The electronics box 176 in this example is coupled to the bed support 112 and houses critical electronic components for the 3D printer 100, including, but not limited to, the power distribution, signal processing, and control functions. In the present example, the electronics box 176 is disposed immediately adjacent the main bed support 148 of the bed support 112. In the present example, the electronics box 176 has a substantially rectangular shape with a slanted portion that includes two tapped holes (not shown). In the present example, the motherboard 180 is coupled to the electronics box 176 by disposing two fasteners (e.g., screws) into the tapped holes, respectively, formed in the electronics box 176. In turn, the motherboard 180 is disposed outside of and on the electronics box 176, thereby allow for efficient cooling of the motherboard 180 in operation. However, one of ordinary skill in the art would understand that the electronics box 176 can have a different shape (e.g., an entirely rectangular shape, an irregular shape) and/or can be located elsewhere on the 3D printer 100 (e.g., coupled to and disposed immediately adjacent the bed motor frame 132). The 3D printer 100 can also include a fan, circulating coolant, heat sink, or other cooling means to help dissipate heat generated by the electronics box 176. Moreover, while in the present example the motherboard 180 is a conventional motherboard such as the BigTree Tech SKR mini E3 v3, one of ordinary skill in the art would understand that any other motherboard could be used in other examples.

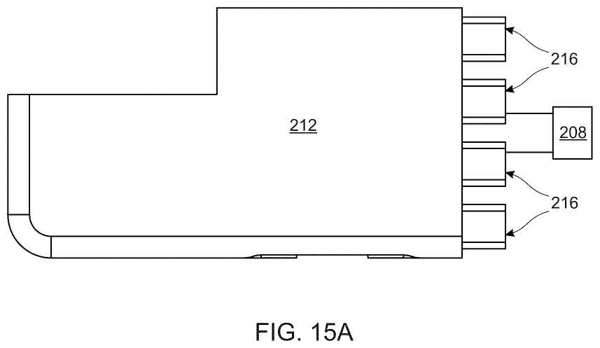

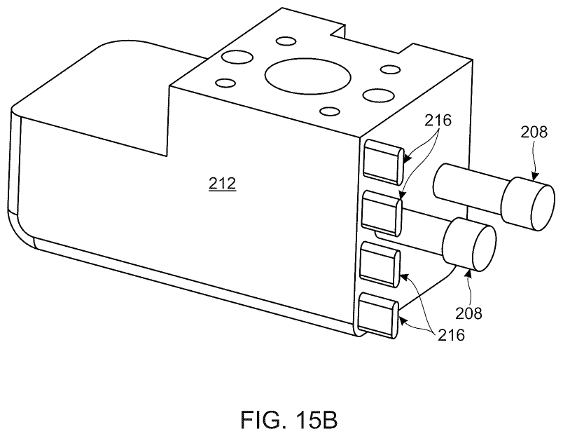

As best illustrated in FIG. 15, the first housing 212 includes the projections 208 for the pin slot and the slot-shaped extrusions 216 for the openings 128 or 129. The projections 208 in this example are cylindrical and the slot-shaped extrusions 216 are substantially rectangular in the present example, but one of skill in the art would understand that the projections 208 and/or the extrusions 216 can have a different shape and yet still be disposed in the pin slots 120 and the openings 128, respectively. Moreover, although there are two projections 208 corresponding with the two pin slots 120, one of skill in the art would understand that any number of projections 208 would be suitable to couple the extruder assembly 200 to the slot frame 116.

The extruder assembly 200 generally includes the extruder 200 as well as a first support 220, the first housing 212, a first motor 224, a first support cap 228, a second support 232, a second housing 236, a second motor 240, and a second support cap 244. As briefly discussed above, the extruder 204 is configured to print or extrude 3D parts on the bed 108 when the 3D printer 100 is in its extruding configuration. In this example, the extruder 204 is a commercially available extruder (e.g., made by Creality and part of Creality's Ender 3 3D printer system). However, one of ordinary skill in the art would understand that a different extruder can be used instead. As previously mentioned and as best illustrated by FIG. 1, in the present example, the first housing 212—which is also referred to herein as the pin support—couples the extruder assembly 200 to the slot frame 116 through the pin slots 120. The first housing 212 also provides a compact and organized housing for the first motor 224 along with any associated necessary mechanical components (which are known to one of skill in the art and so not discussed in further detail here). Meanwhile, the second housing 236 is spaced from the first housing 212 and provides a compact and organized housing for the second motor 240. In the present example, the first housing 212 and the second housing 236 are each 3D printed parts manufactured of PLA. However, one of ordinary skill in the art would understand that the first housing 212 and/or the second housing 236 can be manufactured of any suitable material, including but not limited to a metal or hard plastic material.

The first support cap 228 is generally configured to limit movement and define the extent of the travel path of the second housing 236 in the Z-direction when the extruder assembly 200 is the extruding configuration. Similarly, the second support cap 244 is generally configured to limit movement and define the extent of the travel path of the extruder 204 in the Y-direction when the extruder assembly 200 is in the extruding configuration. In this example, the first support cap 228 is coupled to the first support 220 at an end opposite the first housing 212. Similarly, the second support cap 244 is coupled to the second support 232 at an end opposite the second housing 236. In the present example, each of the first support cap 228 and the second support cap 244 is a 3D-printed part manufactured of PLA; however, one of ordinary skill in the art will appreciate that the first support cap 228 and/or the second support cap 244 can be manufactured of any suitable material, including but not limited to a metal or hard plastic material.

Furthermore, in the present example, the first support 220 includes two first rods 248, 252 that couple the first housing 212, the second housing 236 and the first support cap 228 together. In this example, each of the rods 248, 252 is a linear rod that extends in the Z-direction when the 3D printer 100 is in its extruding configuration but extends in the X-direction when the 3D printer 100 is in its folded configuration. One of ordinary skill in the art would understand that the first support 220 may instead include a different number of rods (e.g., one, three, or more than three rods), and the rods may be manufactured of any suitable rigid material. As best illustrated in FIG. 1, the first housing 212 and the first support cap 228 are coupled to opposite ends of each of the two first linear rods 248, 252, with the second housing 236 positioned between the first housing 212 and the first support cap 228.

In the present example, the first motor 224 is generally configured to drive movement of the extruder 204 in the Z-direction relative to the base assembly 104 and the first housing 212 when the 3D printer 100 is in its extruding configuration. More particularly, in the present example the first motor 224 takes the form of a Nema 17 stepper motor, and the first housing 212 includes a conventional leadscrew system (not shown) configured to provide for precise vertical movement of the second housing 236 in the Z-direction when the 3D printer 100 is in the extruding configuration. Meanwhile, in the present example, the second housing 236 includes a T8 leadscrew brass nut compatible with the leadscrew system to generate the vertical movement from the rotational movement of the first motor 224. However, one of skill in the art would understand that any similar systems configured to create vertical movement can be utilized, including but not limited to a rack and pinion or a motor and belt configuration.

Additionally, in the present example, the second support 232—also referred to herein as the extruder support-includes two second rods 256, 260 that couple the second housing 236, the extruder 204, and the second support cap 244 together. In this example, each of the rods 256, 260 is a linear rod that extends in the Y-direction when the 3D printer is in both its extruding and folded configurations. One of ordinary skill in the art would, however, understand that the second support 232 can instead include a different number of rods (e.g., one, three, or more than three rods), and the rods may be manufactured of any suitable rigid material. The second housing 236 and the second support cap 244 are coupled to opposite ends of each of the two second linear rods 256, 260, with the extruder 204 disposed between the second housing 236 and the second support cap 244. In the present example, the second motor 240 is configured to drive movement of the extruder 204 in the Y-direction relative to the base assembly 104 (and the second housing 236) when the 3D printer 100 is in its extruding configuration. More particularly, in the present example the second motor 240 takes the form of a Nema 17 pancake stepper motor configured to run a conventional pulley system (not shown) that moves the extruder 204 in the Y-direction when the 3D printer 100 is in the extruding configuration. Meanwhile, the second support cap 244 includes a mount opposite the second motor 240 for a belt of the pulley system. However, although the present example utilizes a pulley system, one of ordinary skill in the art would understand that other similar systems, including but not limited to a rack and pinion or lead screw system, can also be used to drive movement of the extruder 204 via the second motor 240.

As discussed above, the 3D printer 100 (and the extruder assembly 200 more particularly) is reconfigurable between the extruding configuration and the folded configuration. In this example, in the folded configuration the projections 208 of the extruder assembly 200 are disposed in the pin slots 120, respectively, the slot extrusions 216 are disposed in the openings 129, respectively, in the slot frame 116 and the slider lock 124 is disposed in the opening 117 of the slot frame 116, thereby securing the extruder 204 in position above the base assembly 104 and to create printed parts on the bed 108. To move the 3D printer 100 from the extruding configuration to the folded configuration, the projections 208 of the extruder assembly 200 are generally moved along the pin slots 120 of the slot frame 116 from the first stops 121a, 121b to the second stops 121b, 122b, respectively.

To do so, the extruder assembly 200 is first moved away from base assembly 104 such that the slot-shaped extrusions 216 are removed from and spaced apart from the openings 129 of the slot frame 116, respectively but the projections 208 nonetheless remain disposed within the slots 120a, 120b, respectively, at the first stop 121a and the first stop 121b, respectively. Second, the extruder assembly 200 is manipulated such that the projections 208 are moved through the pin slots 120, respectively, until the projections 208 are disposed within the slots 120a, 120b at the intermediate stop 121c and the second stop 122b, respectively. Third, the extruder assembly 200 is rotated within the pin slots 120 of the slot frame 116 such that the projections 208 of the first housing 212 of the extruder assembly 200 are moved within the pin slots 120, respectively to the second stop 121b and second stop 122b, and the plane created by the extruder assembly 200 is perpendicular to the x-y plane. Fourth, because the slot-shaped extrusions 216 are spaced away from the slot frame 116, the first housing 212 can be manipulated so that the slot-shaped extrusions 216 are aligned with and inserted in the openings 128, respectively, of the slot frame 116. In turn, the extruder assembly 200 is now placed in the extruding configuration. With the extruder assembly 200 in the extruding configuration, the extruder 204 is operable print parts on the bed 108 of the base assembly 104 responsive to a control signal, for example from the motherboard 180. In this example, the motherboard 180 transmits a control signal to the extruder 204 to begin printing on the bed 108 when the user connects an external device (not shown) to the motherboard via a cable (e.g., a micro-USB cable, not shown) and the external device provides data (e.g., a build file) for the part(s) to the motherboard 180. One of skill in the art will appreciate that the external device may include, for example, a computer, a mobile phone, a remote control, or a tablet, and/or the 3D printer 100 may include a control panel with a screen or other buttons configured to begin a print operation responsive to data transferred from the external device. Alternatively, one of skill in the art will appreciate that the external device may transmit the data to the motherboard 180 via a wireless connection.

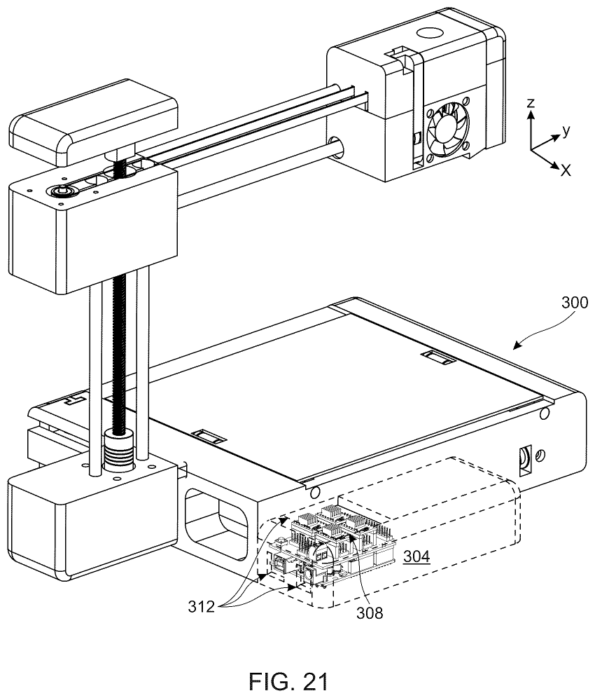

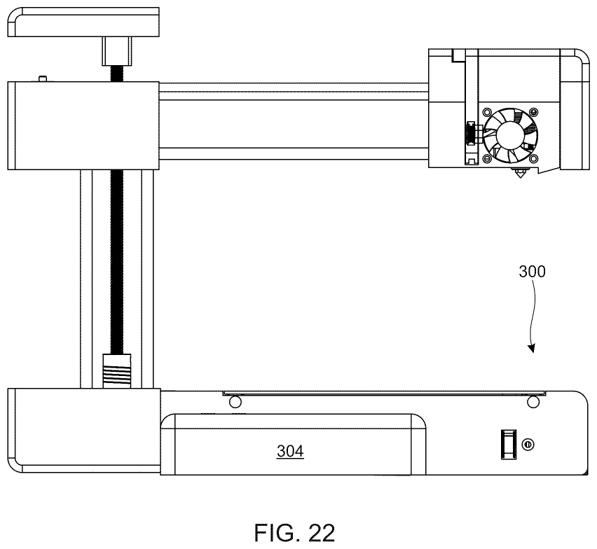

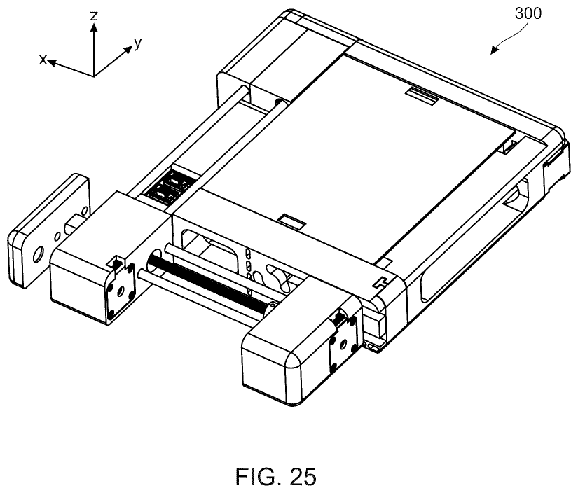

FIGS. 21-25 illustrate a second example of a 3D printer 300 that is constructed in accordance with the teachings of the present disclosure. The 3D printer 300 is substantially similar to the 3D printer 100 of FIGS. 1-14 except for the differences described below. Like the 3D printer 100, the 3D printer 300 is reconfigurable between a folded configuration and an extruded configuration, and when the 3D printer 300 is in the extruded configuration, the 3D printer 300 has an extruder that is configured to print parts on a bed. However, the 3D printer 300 has an electronics box 304 (depicted transparently in FIG. 21), a bed plate extrusion 316, and a bed frame 318 that differ from the electronics box 176, the bed plate extrusion 184, and the bed frame 112, respectively, of the 3D printer 100.

As best illustrated by FIGS. 21-23 and 25, the electronics box 304 is different from the electronics box 176 in that the electronics box 304 is substantially rectangular and at least partially encloses the motherboard 308 (which is similar to the motherboard 180 discussed above). In turn, the electronics box 304 helps to protect the motherboard 308. At the same time, the electronics box 308 includes openings 312 that allow access to various ports of the motherboard 308 including, for example, a USB port or power supply port, and heat generated by the motherboard 308 can dissipate into the environment in which the 3D printer 300 is in. In the present example, the motherboard 308 is a 3D-printed part and manufactured of PLA. However, one of ordinary skill in the art would appreciate that the electronics box 304 can have a different shape (e.g., a square, a cylindrical, or irregular shape) and/or can be made of one or more different materials including, for example, a hard plastic or metal.

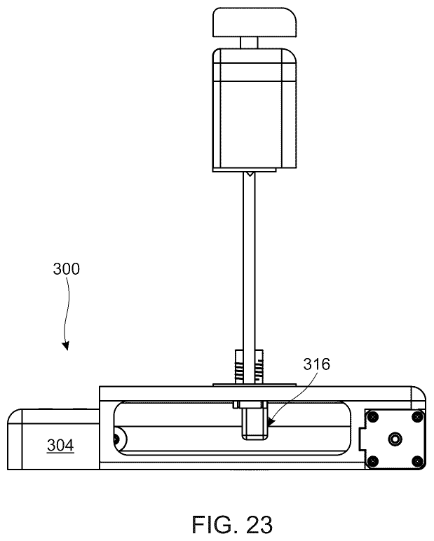

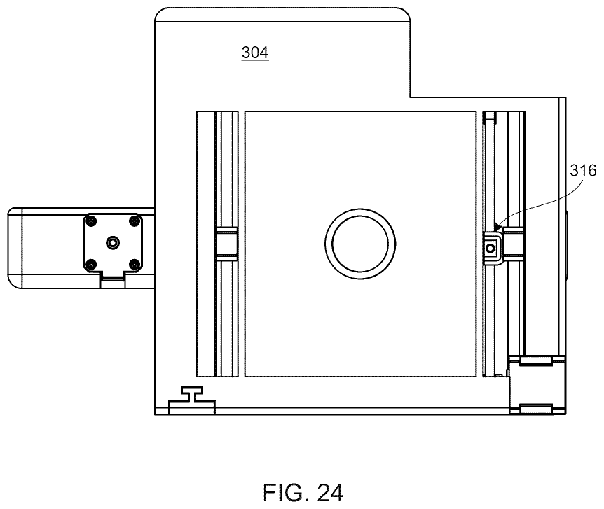

As best illustrated by FIGS. 23-24, the bed plate extrusion 316 is substantially rectangular with rounded edges. As with the bed plate extrusion 184, the bed plate extrusion 316 is secured to a belt 324 by a teethed board 320 that attaches to the teeth of the belt 324 to actuate movement created by the pulley-belt system as in the first example of the 3D printer 100. In the present example, the bed plate extrusion 316 is a 3D-printed part manufactured of PLA. However, as with the bed plate extrusion 184, one of ordinary skill in the art would appreciate that the bed plate extrusion 316 can be made of one or more different materials, including but not limited to a hard plastic or metal.

As best illustrated by FIG. 24, unlike the bed frame 112, which includes the main bed supports 144, 148, the bed frame 318 includes a single main bed support 328 that supports the bed 108. In this example, the main bed support 328 is a 3D-printed part manufactured of PLA. However, one of ordinary skill in the art would appreciate that the main bed side 328 can be made of one or more different materials, including a hard plastic or metal material.

1. A 3D printer configured to be foldable and portable, comprising:
a base assembly; and
an extruder assembly coupled to the base assembly, the extruder assembly comprising an extruder;
wherein the 3D printer is reconfigurable between a folded configuration, in which the base assembly is substantially co-planar to the extruder, and an extruding configuration, in which the extruder is disposed above the base assembly and configured to print parts on the base assembly.

2. The 3D printer of claim 1, wherein the base assembly comprises a slot frame that receives the extruder assembly to secure the extruder assembly to the base assembly such that the 3D printer is movable from the folded configuration to the extruding configuration.

3. The 3D printer of claim 2, wherein the slot frame comprises a slot that facilitates the reconfiguration between the folded configuration and the extruding configuration.

4. The 3D printer of claim 3, wherein the slot extends along the length of the base assembly.

5. The 3D printer of claim 3, wherein the slot is recessed within the base assembly.

6. The 3D printer of claim 2, wherein the slot frame comprises a plurality of slots and wherein the extruder assembly comprises a plurality of projections movably disposed in the plurality of slots, respectively, to move the 3D printer between the folded configuration and the extruded configuration.

7. The 3D printer of claim 1, wherein the base assembly comprises a bed for supporting the printed parts, wherein the bed lies in a plane defined by a first axis and a second axis, and wherein when the 3D printer is in the extruding configuration, the extruder is movable along a third axis perpendicular to the plane.

8. The 3D printer of claim 2, further comprising a removable locking mechanism, wherein when the locking mechanism is coupled to the base assembly, the locking mechanism prevents movement of the extruder assembly out of the slot frame.

9. The 3D printer of claim 7, wherein the extruder assembly further comprises an extruder support for supporting the extruder, wherein the extruder moves along the second axis when the 3D printer is in the extruding configuration.

10. The 3D printer of claim 7, further comprising a first motor that produces motion of the extruder along the third axis and a second motor that produces motion of the extruder along the second axis.

11. The 3D printer of claim 7, wherein the extruder assembly comprises a first support for the extruder, wherein the length of the first support extends along the third axis when the extruder assembly is in the extruding configuration.

12. The 3D printer of claim 1, wherein the slot frame comprises a plurality of first openings and a plurality of second openings, wherein the extruder assembly further comprises an extruder housing coupled to the extruder and comprising a plurality of slot extrusions, wherein the slot extrusions are disposed in the first openings, respectively, to secure the extruder assembly to the base assembly when the 3D printer is in the extruding configuration, and wherein the slot extrusions are disposed in the second openings, respectively, to secure the extruder assembly to the base assembly when the 3D printer is in the folded configuration.

13. A 3D printer configured to be foldable and portable, comprising:
a base assembly comprising:
a bed;
a bed support for the bed; and
a slot frame coupled to the bed support, the slot frame comprising one or more slots; and
an extruder assembly coupled to the base assembly and comprising:
an extruder; and
an extruder housing coupled to the extruder and comprising one or more projections movably disposed in the one or more slots, respectively;
wherein the 3D printer is reconfigurable between a folded configuration, in which the base assembly is co-planar to the extruder assembly, and an extruding configuration, in which the extruder assembly is disposed above the base assembly and configured to print parts on the bed, via movement of the one or more projections in the one or more slots.

14. The 3D printer of claim 13, wherein the slot frame extends along the length of the base assembly.

15. The 3D printer of claim 13, wherein the one or more slots are recessed within the base assembly.

16. The 3D printer of claim 13, wherein the slot frame comprises a plurality of slots and the base assembly comprises a plurality of projections movably disposed in the plurality of slots.

17. The 3D printer of claim 13, wherein the bed lies in a plane defined by a first axis and a second axis, and wherein when the 3D printer is in the extruding configuration, the extruder is movable along a third axis perpendicular to the plane.

18. The 3D printer of claim 13, further comprising a removable locking mechanism, wherein when the locking mechanism is coupled to the base assembly, the locking mechanism prevents movement of the extruder assembly out of the slot frame.

19. The 3D printer of claim 17, wherein the base assembly comprises a bed motor configured to move the bed along the first axis when the 3D printer is in the extruding configuration.

20. The 3D printer of claim 13, wherein the slot frame comprises a plurality of first openings and a plurality of second openings, wherein the extruder housing comprises a plurality of slot extrusions, wherein the slot extrusions are disposed in the first openings, respectively, to secure the extruder assembly to the base assembly when the 3D printer is in the extruding configuration, and wherein the slot extrusions are disposed in the second openings, respectively, to secure the extruder assembly to the base assembly when the 3D printer is in the folded configuration.
